(19) United States
(12) Patent Application Publication
(10) Pub. No.: US 2012/0274971 A1
(43) Pub. Date: Nov. 1, 2012

(54) IMAGE FORMING APPARATUS, IMAGE FORMING METHOD, AND COMPUTER READABLE MEDIUM

(75) Inventor: Shigeru TANABE, Kanagawa (JP)

(73) Assignee: FUJI XEROX CO., LTD., Tokyo (JP)

(21) Appl. No.: 13/297,793

(22) Filed: Nov. 16, 2011

(30) Foreign Application Priority Data
Apr. 26, 2011 (JP) 2011-098310

(51) Int. Cl. G06F 3/12

(52) U.S. Cl. 358/1.14

(57) ABSTRACT

An image forming apparatus includes an authentication unit, a communication unit, a function availability data obtaining unit, a usage authorization data obtaining unit, and a display controller. The authentication unit authenticates a user. The communication unit communicates with an external device connected thereto. The function availability data obtaining unit obtains, from a memory, function availability data that defines whether or not a function related to the external device is available. The usage authorization data obtaining unit obtains usage authorization data indicating whether or not the user is authorized to use the function. The display controller causes, when the external device is connected to the communication unit, a display to display a screen related to authentication of the user, an image related to the function, or an image for notifying the user that the function is unavailable, in accordance with the function availability data or the usage authorization data.

### CROSS-REFERENCE TO RELATED APPLICATIONS

This application is based on and claims priority under 35 USC 119 from Japanese Patent Application No. 2011-098310 filed Apr. 26, 2011.

### BACKGROUND

(i) Technical Field

The present invention relates to an image forming apparatus, an image forming method, and a computer readable medium.

### SUMMARY

According to an aspect of the invention, there is provided an image forming apparatus including an authentication unit, a communication unit, a function availability data obtaining unit, a usage authorization data obtaining unit, and a display controller. The authentication unit authenticates a user. The communication unit communicates with an external device connected thereto. The function availability data obtaining unit obtains, from a memory, function availability data that defines whether or not a function related to the external device is available. The usage authorization data obtaining unit obtains usage authorization data indicating whether or not the user is authorized to use the function. The display controller causes, when the external device is connected to the communication unit, a display to display a screen related to authentication of the user in a case where the function availability data indicates that the function is unavailable in a state where the user has not been authenticated. Also, the display controller causes, when the external device is connected to the communication unit, the display to display an image related to the function in a case where the usage authorization data indicates that the function is available and where the function availability data indicates that the function is available in a state where the user has been authenticated. Also, the display controller causes, when the external device is connected to the communication unit, the display to display an image for notifying the user that the function is unavailable in a case where the usage authorization data indicates that the function is unavailable in a state where the user has been authenticated.

### BRIEF DESCRIPTION OF THE DRAWINGS

Exemplary embodiment(s) of the present invention will be described in detail based on the following figures, wherein:

FIG. 1 is a diagram illustrating a system according to an exemplary embodiment of the present invention;

FIG. 2 is a diagram illustrating a hardware configuration of an image forming apparatus;

FIG. 3 is a diagram illustrating the content of a table;

FIG. 4 is a diagram illustrating a functional configuration of the image forming apparatus;

FIG. 5 is a diagram illustrating a hardware configuration of a server apparatus;

FIG. 6 is a diagram illustrating the content of a table;

FIG. 7 is a diagram illustrating a screen displayed on a display unit;

FIG. 8 is a flowchart illustrating a process performed by a control unit;

FIG. 9 is a diagram illustrating a screen displayed on the display unit;

FIG. 10 is a diagram illustrating a screen displayed on the display unit;

FIG. 11 is a diagram illustrating a screen displayed on the display unit;

FIG. 12 is a diagram illustrating a screen displayed on the display unit;

FIG. 13 is a diagram illustrating a screen displayed on the display unit;

FIG. 14 is a diagram illustrating a screen displayed on the display unit;

FIG. 15 is a flowchart illustrating a process performed by the control unit; and

FIG. 16 is a diagram illustrating a screen displayed on the display unit.

### DETAILED DESCRIPTION

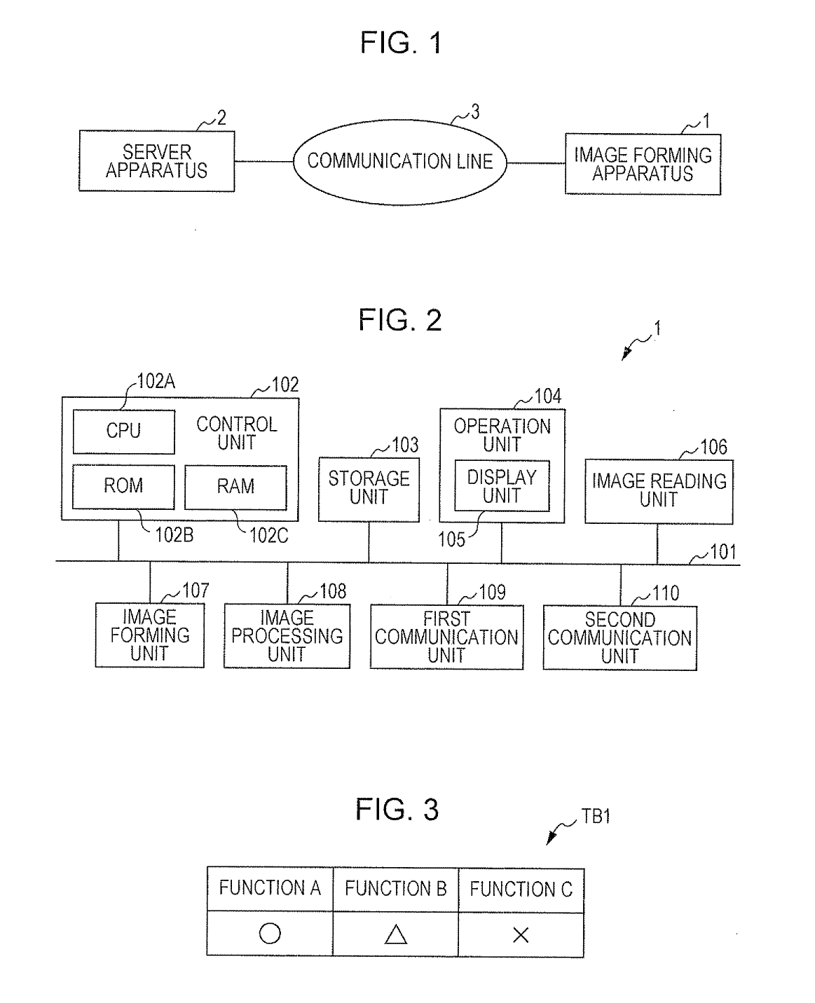

FIG. 1 is a diagram illustrating a system according to an exemplary embodiment of the present invention. A communication line 3 is, for example, a local area network (LAN), and an image forming apparatus 1 and a server apparatus 2 are connected thereto. The communication line 3 is not limited to the LAN, and any types of communication line capable of performing data communication may be used, such as a wide area network (WAN) or the Internet.

The image forming apparatus 1 is an example of an image forming apparatus that forms a color image on a sheet. The image forming apparatus 1 according to the exemplary embodiment is an electrophotographic image forming apparatus. Alternatively, an inkjet image forming apparatus may be used. The image forming apparatus 1 may have a configuration for forming a monochrome image. The image forming apparatus 1 has an image formation function of forming an image on a sheet on the basis of data representing the image, a copy function of copying a document, a read function of reading an image formed on a sheet, etc. The functions of the image forming apparatus 1 are not limited to those described above. For example, the image forming apparatus 1 may have a facsimile function. The image forming apparatus 1 may not necessarily have all the functions described above. For example, the image forming apparatus 1 may have the image formation function and the copy function, and may not have the other functions. Also, the image forming apparatus 1 has a function of obtaining a user identifier (ID) for identifying a user of the image forming apparatus 1 and his/her password, and authenticating the user in cooperation with the server apparatus 2.

The server apparatus 2 is a computer apparatus that functions as a server of a client-server system. The server apparatus 2 is an example of an authentication apparatus that has a function of authenticating a user who uses the image forming apparatus 1.

### Configuration of Image Forming Apparatus 1

FIG. 2 is a diagram illustrating a hardware configuration of the image forming apparatus 1. As illustrated in FIG. 2, the individual units of the image forming apparatus 1 are connected to a bus 101, and transmit data to/receive data from one another via the bus 101.

An operation unit 104 includes plural buttons and a touch screen for operating the image forming apparatus 1. A display unit 105 for displaying an image on the touch screen is a display device, and corresponds to an example of a display that displays an image. Examples of the display unit 105 include a liquid crystal display (LCD) and an organic electroluminescent (EL) display.

A first communication unit 109 is connected to the communication line 3 via a communication cable, and performs data communication with an apparatus connected to the communication line 3 under control performed by a control unit 102.

A second communication unit 110 is an example of a communication unit that performs communication in accordance with a universal serial bus (USB) standard. The second communication unit 110 includes a USB socket into which a USB plug is inserted. The second communication unit 110 relays data communication performed between the control unit 102 and an external device connected to the USB socket. In the exemplary embodiment, an auxiliary storage device from which data is read and on which data is written using the USB standard (for example, a USB memory) is connected to the second communication unit 110. Alternatively, a recording device (for example, a so-called medium reader) that reads data from and writes data on a recording medium that stores data (for example, a nonvolatile semiconductor memory) may be connected to the second communication unit 110.

An image reading unit 106 includes an image reading device (not illustrated) that optically reads a document and generates image data representing an image of the read document. The image reading unit 106 outputs the generated image data to an image processing unit 108. The image processing unit 108 performs various processing operations on image data input thereto. The image processing unit 108 performs image processing, such as color correction or gradation correction, on an image represented by image data input thereto, generates image data of images of individual colors including yellow (Y), magenta (M), cyan (C), and black (K) from the image on which image processing has been performed, and outputs the generated image data to an image forming unit 107.

The image forming unit 107 includes an image forming section (not illustrated) that forms toner images on a sheet using electrophotography. Specifically, the image forming section includes an image forming part that forms an yellow toner image, an image forming part that forms a magenta toner image, an image forming part that forms a cyan toner image, and an image forming part that forms a black toner image. The individual image forming parts form electrostatic latent images on photoconductive members in accordance with image data generated by the image reading unit 106, data received by the first communication unit 109, or data obtained by the second communication unit 110, cause toners to be adhered onto the surfaces of the respective photoconductive members to form toner images of Y, M, C, and K, and transfer the toner images onto a sheet. Then, the image forming section applies heat and pressure to the toner images transferred onto the sheet so as to fix the toner images onto the sheet, and outputs the sheet to the outside of the image forming apparatus 1. In the exemplary embodiment, an image is formed on a sheet using toner. Alternatively, an image may be formed on a sheet using ink on the basis of an inkjet scheme or the like. A medium on which an image is formed is not limited to paper, and a sheet made of transparent synthetic resin used for an overhead projector (OHP) or the like may be used.

The control unit 102 according to the exemplary embodiment is a so-called microcomputer that includes a central processing unit (CPU) 102A, a read only memory (ROM) 102B, and a random access memory (RAM) 102C. When the CPU 102A executes a program stored in the ROM 102B, the above-described image formation function, copy function, read function, user authentication function, or the like is realized. Also, when the CPU 102A executes a program stored in the ROM 102B, a function of detecting that an external device has been connected to the second communication unit 110, a function of reading data from or writing data on an auxiliary storage device connected to the second communication unit 110, a function of displaying a screen related to the auxiliary storage device connected to the second communication unit 110 on the display unit 105, or the like is realized.

A storage unit 103 includes a storage device that stores data (for example, a hard disk device). The device that stores data is not limited to the hard disk device, and a semiconductor memory may be used. The storage unit 103 stores data received by the first communication unit 109, data generated by the image reading unit 106, data related to the setting of the image forming apparatus 1, etc. Examples of the data related to the setting of the image forming apparatus 1 include first setting data and second setting data. The first setting data is data that specifies the operation of the image forming apparatus 1 when an auxiliary storage device is connected to the second communication unit 110. In the exemplary embodiment, the content of the first setting data is any one of “not changed”, “activate function A”, “activate function B”, “activate function C”, and “display selection screen”. The second setting data is data that indicates the protection level of the image forming apparatus 1. In the exemplary embodiment, the content of the second setting data is any one of “high” and “low”.

The storage unit 103 stores a table TB1 illustrated in FIG. 3. The table TB1 stores function availability data that indicates whether or not each of functions A to C of the image forming apparatus 1 is available. In the exemplary embodiment, functions A to C are functions executed by using an auxiliary storage device.

When a circle mark is stored in the column “function A” in the table TB1, display related to function A is performed on the display unit 105 and function A becomes available even in an unauthenticated state (logout state) in which a user has not yet been authenticated in the image forming apparatus 1. When a triangle mark is stored in the column “function A”, display related to function A is performed on the display unit 105 but function A is unavailable in an unauthenticated state. When a cross mark is stored in the column “function A”, function A is unavailable and display related to function A is not performed on the display unit 105 in the image forming apparatus 1 in an unauthenticated state.

### Functional Configuration of Image Forming Apparatus 1

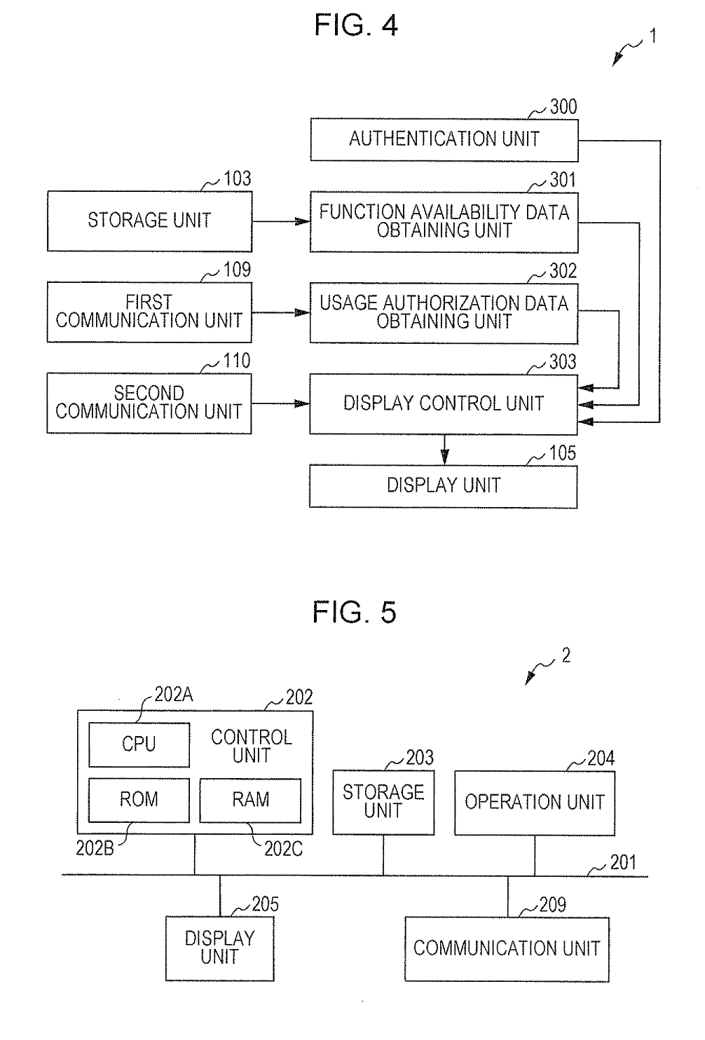

FIG. 4 is a block diagram illustrating a functional configuration realized by the control unit 102.

An authentication unit 300 is an example of an authentication unit that authenticates a user of the image forming apparatus 1. The authentication unit 300 transmits a user ID and a password input through the operation unit 104 to the server apparatus 2 via the first communication unit 109. Also, the authentication unit 300 obtains the result of a user authentication process performed in the server apparatus 2. The authentication unit 300 shifts the state of the image forming apparatus 1 to an unauthenticated state in which a user has not yet been authenticated or an authenticated state in which a user has been authenticated, on the basis of the obtained result.

A function availability data obtaining unit 301 is an example of a function availability data obtaining unit that obtains function availability data. The function availability data obtaining unit 301 obtains function availability data in the table TB1 stored in the storage unit 103, and supplies the obtained function availability data to a display control unit 303.

A usage authorization data obtaining unit 302 is an example of a usage authorization data obtaining unit that obtains usage authorization data. The usage authorization data obtaining unit 302 obtains usage authorization data, which is received by the first communication unit 109 from the server apparatus 2, and supplies the obtained usage authorization data to the display control unit 303.

The display control unit 303 is an example of a display controller that controls an image displayed on the display unit 105. The display control unit 303 causes an image to be displayed on the display unit 105 on the basis of function availability data and usage authorization data when an auxiliary storage device is connected to the second communication unit 110 in an authenticated state. Also, the display control unit 303 causes an image to be displayed on the display unit 105 on the basis of function availability data when an auxiliary storage device is connected to the second communication unit 110 in an unauthenticated state.

### Configuration of Server Apparatus 2

FIG. 5 is a block diagram illustrating a hardware configuration of the server apparatus 2. As illustrated in FIG. 5, the individual units of the server apparatus 2 are connected to a bus 201, so that data is transmitted/received among the units via the bus 201. In the exemplary embodiment, an operation unit 204 includes a keyboard and a mouse for operating the server apparatus 2. A display unit 205 includes a display device. Examples of the display device include an LCD and an organic EL display. A communication unit 209 is connected to the communication line 3 via a communication cable, and performs data communication with an apparatus connected to the communication line 3.

A storage unit 203 includes a storage device that stores data (for example, a hard disk device), and stores a program for realizing a server function in a client-server system, a program for realizing a function of authenticating a user who uses the image forming apparatus 1, and the like. Also, the storage unit 203 stores various data for authenticating a user of the image forming apparatus 1, and usage authorization data indicating whether or not each of functions A to C is available to a user. The usage, authorization data is stored in association with individual users.

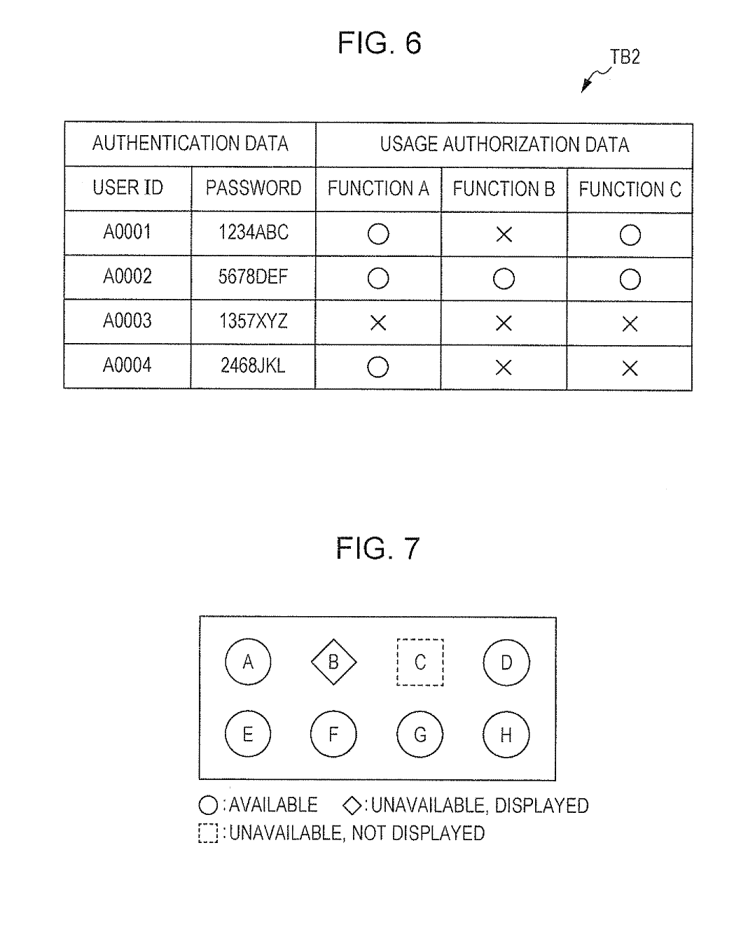

FIG. 6 is a diagram illustrating the content of a table TB2, which stores authentication data for authenticating a user and usage authorization data indicating the usage authorization for each function of the image forming apparatus 1. In the table TB2, the column “authentication data” includes a column “user ID” and a column “password”. User IDs for identifying individual users are stored in the column “user ID”. A user ID may be a combination of numerals and alphabetic characters, or may be the name of a user expressed by “Hiragana”, “Katakana”, or “Kanji” characters. Passwords set by individual users are stored in the column “password”.

Also, the table TB2 has columns “function A”, “function B”, and “function C” as columns for storing usage authorization data. Regarding each function, a circle mark is stored if the user identified by a user ID is authorized to use the function, and a cross mark is stored if the user is not authorized to use the function. For example, it is assumed that function A is available to the user whose user ID is “A0004”, and that functions B and C are unavailable to the user. In this case, a circle mark is stored in the column “function A” in the row including “A0004”, and a cross mark is stored in the columns “function B” and “function C”, as illustrated in FIG. 6.

A control unit 202 according to the exemplary embodiment includes a CPU 202A, a ROM 202B, and a RAM 202C. The CPU 202A executes a program stored in the ROM 202B and various programs stored in the storage unit 203. When the CPU 202A executes a program, the control unit 202 controls the individual units, so that the above-described server function or user authentication function is realized.

### OPERATION ACCORDING TO EXEMPLARY EMBODIMENT

Next, a characteristic operation of the image forming apparatus 1 according to the exemplary embodiment will be described.

### Operation in Unauthenticated State

First, a description will be given of an operation that is performed when a USB memory is connected to the second communication unit 110 in an unauthenticated state. When the USB memory is not connected to the second communication unit 110 in the image forming apparatus 1 in an unauthenticated state, a screen for activating a function of the image forming apparatus 1 (see FIG. 7) is displayed on the display unit 105 in accordance with the content of the table TB1. In FIG. 7, an image of an alphabetic character in a circle represents that the function corresponding to the image is available. In the example illustrated in FIG. 7, functions A and D to H are available to a user. An image of an alphabetic character in a rhombus represents that the function corresponding to the image is unavailable. In FIG. 7, an image of an alphabetic character in a broken-line square is not actually displayed, so that a user is incapable of activating the function corresponding to this image.

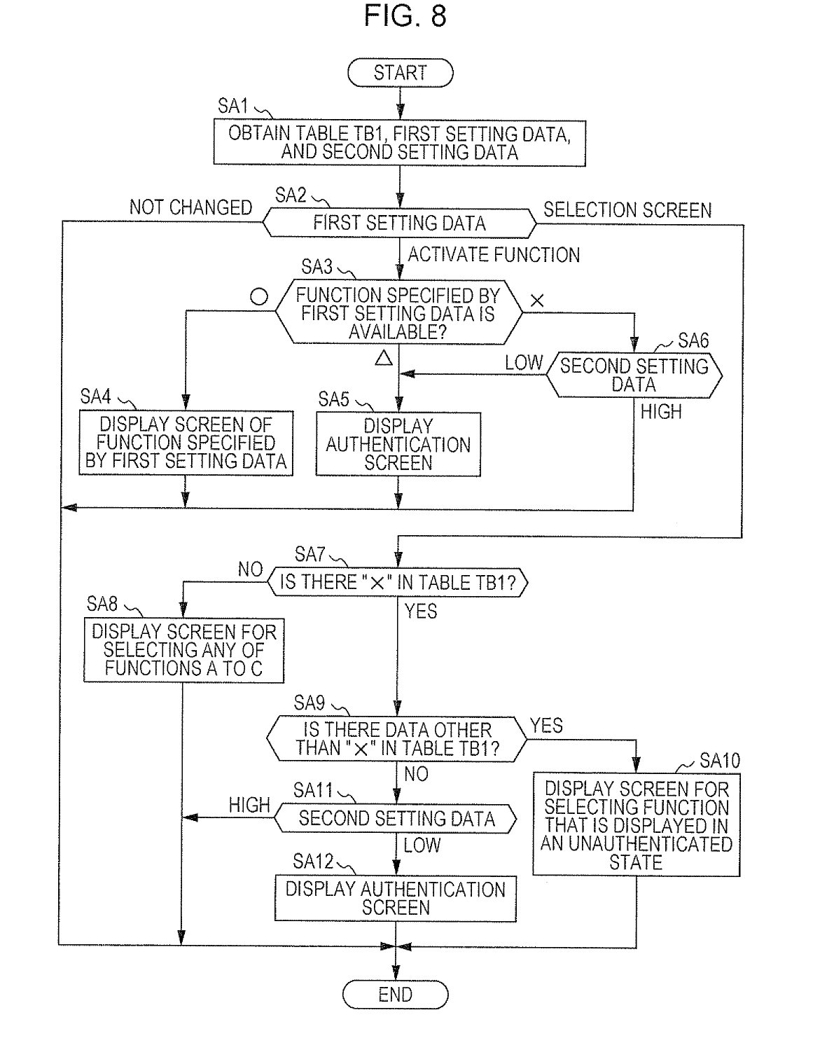

When a USB memory is connected to the second communication unit 110 in the image forming apparatus 1 in an unauthenticated state, the control unit 102 executes the process illustrated in FIG. 8. First, the control unit 102 obtains the table TB1, the first setting data, and the second setting data, which are stored in the storage unit 103 (step SA1). If the content of the obtained first setting data is “not changed” (“not changed” in step SA2), the control unit 102 ends the process illustrated in FIG. 8 without changing the screen on the display unit 105.

If the content of the obtained first setting data is any one of “activate function A”, “activate function B”, and “activate function C” (“activate function” in step SA2), the control unit 102 determines whether or not the function specified by the first setting data is available. For example, if the content of the first setting data is “activate function A”, the control unit 102 refers to the column “function A” of the table TB1. If a circle mark is stored in the column “function A”, as illustrated in FIG. 3 (“circle” in step SA3), the control unit 102 causes the display unit 105 to display a screen related to the function specified by the first setting data, that is, a screen related to function A (step SA4). For example, if function A is a copy function, a menu screen that allows a user to set the number of copies, monochrome or color, the size of sheet to be used, and so forth, is displayed.

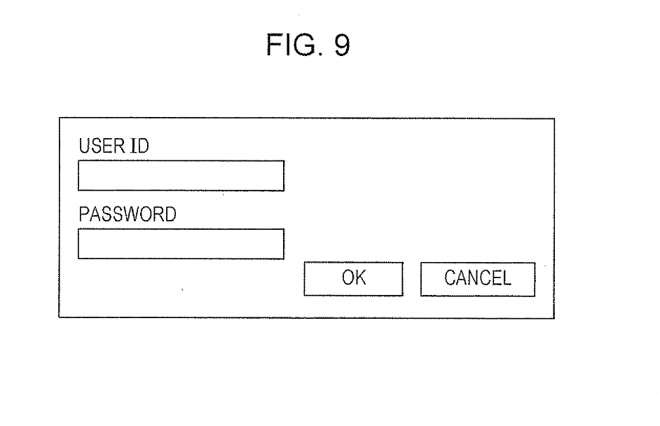

If the content of the first setting data is “activate function B”, the control unit 102 refers to the column “function B” of the table TB1. If a triangle mark is stored in the column “function B”, as illustrated in FIG. 3 (“triangle” in step SA3), the control unit 102 causes the display unit 105 to display an authentication screen (see FIG. 9) that allows a user to input a user ID and a password (step SA5).

If the content of the first setting data is “activate function C”, the control unit 102 refers to the column “function C” of the table TB1. If a cross mark is stored in the column “function C”, as illustrated in FIG. 3 (“cross” in step SA3), the control unit 102 determines the content of the second setting data. If the content of the second setting data is “low” (“low” in step SA6), the control unit 102 causes the display unit 105 to display the authentication screen (see FIG. 9) in step SA5. If the content of the second setting data is “high” (“high” in step SA6), the control unit 102 ends the process illustrated in FIG. 8 without changing the screen on the display unit 105.

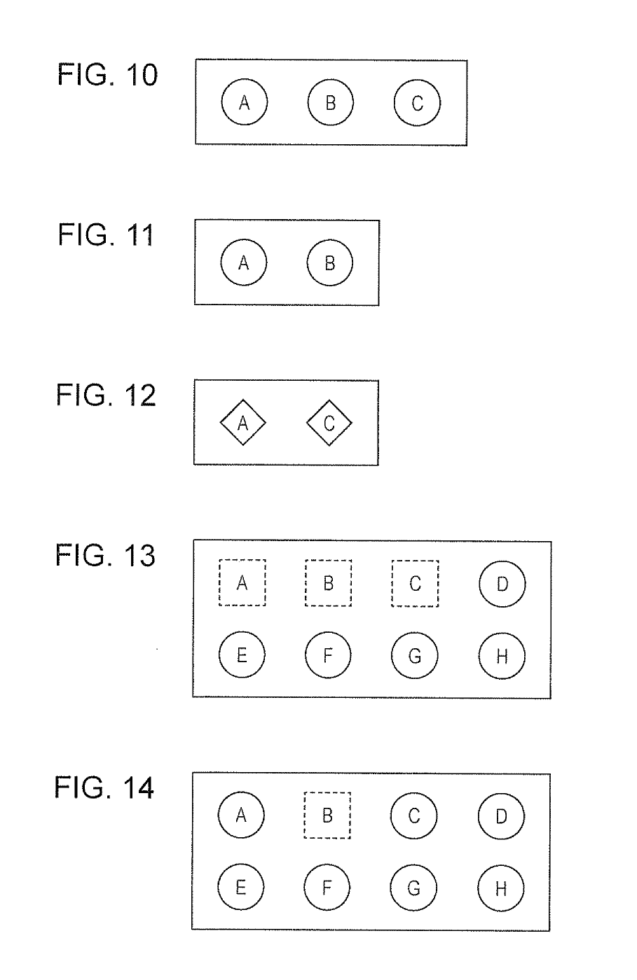

If the content of the first setting data is “selection screen” (“selection screen” in step SA2), the control unit 102 determines whether or not a cross mark is stored in the table TB1. If no cross mark is stored in the table TB1 (NO in step SA7), the control unit 102 causes the display unit 105 to display a screen that allows a user to select any one of functions A to C (see FIG. 10). On the other hand, if a cross mark is stored in the table TB1 (YES in step SA7), the control unit 102 determines whether data other than a cross mark is stored in the table TB1. If data other than a cross mark is stored in the table TB1 (YES in step SA9), the control unit 102 causes the display unit 105 to display a screen that allows a user to select a function corresponding to a circle mark or a function corresponding to a triangle mark in the table TB1, that is, a function displayed in an unauthenticated state (step SA10). For example, if the content illustrated in FIG. 3 is stored in the table TB1, a screen that allows a user to select any one of function A and function B is displayed on the display unit 105, as illustrated in FIG. 11.

On the other hand, if a negative determination is made in step SA9, the process proceeds to step SA11. If the content of the second setting data is “low” (“low” in step SA11), the control unit 102 causes the display unit 105 to display the authentication screen (see FIG. 9) in step SA12. If the content of the second setting data is “high” (“high” in step SA11), the control unit 102 ends the process illustrated in FIG. 8 without changing the screen on the display unit 105. For example, if the content illustrated in FIG. 3 is stored in the table TB1 and if the content of the first setting data is “selection screen”, the screen illustrated in FIG. 11 is displayed.

For example, if a triangle mark is stored for function A, a cross mark is stored for function B, and a triangle mark is stored for function C in the table TB1, and if the content of the first setting data is “selection screen”, the screen illustrated in FIG. 12 is displayed. Also, if cross marks are stored for functions A to C in the table TB1, if the content of the first setting data is “selection screen”, and if the content of the second setting data is “high”, the screen illustrated in FIG. 13 is displayed. If the content of the second setting data is “low”, the authentication screen illustrated in FIG. 9 is displayed.

As described above, the image forming apparatus 1 according to the exemplary embodiment stores the table TB1 and the first setting data. When an auxiliary storage device is connected to the image forming apparatus 1 in an unauthenticated state, a screen related to a function related to the auxiliary storage device is displayed on the basis of the table TB1 and the content of the first setting data, even if the user does not perform any operations.

Also, the image forming apparatus 1 according to the exemplary embodiment stores the second setting data. If a screen related to a function related to the auxiliary storage device is not displayed in an unauthenticated state, the authentication screen is displayed or the screen is not changed on the basis of the content of the second setting data.

### Operation of Authenticating User

Next, an operation of authenticating a user, which is performed through cooperation between the image forming apparatus 1 and the server apparatus 2, will be described. After a user has been authenticated in the image forming apparatus 1, the user is capable of using a function that is not available in an unauthenticated state in accordance with the content of the table TB2. When the user performs an operation of providing an instruction to display an input screen for inputting a user ID and a password using the operation unit 104, the screen illustrated in FIG. 9 is displayed on the display unit 105 of the touch screen, so that the user is allowed to input a user ID and a password. In the exemplary embodiment, the user ID and password are input using a keyboard (a so-called software keyboard) displayed on the display unit 105.

When the user touches the “OK” button on the screen illustrated in FIG. 9 after inputting the user ID and password, the input user ID and password are transmitted to the server apparatus 2. Accordingly, the control unit 202 of the server apparatus 2 receives the user ID and password, and searches the table TB2 for the set of the received user ID and password. When finding the set of the user ID and password in the table TB2, the control unit 202 obtains, from the table TB2, the usage authorization data associated with the set. After obtaining the usage authorization data, the control unit 202 transmits a message indicating that the user has been successfully authenticated and the obtained usage authorization data to the image forming apparatus 1. If the set of the user ID and password is not found in the table TB2, the control unit 202 transmits a message indicating that user authentication has failed to the image forming apparatus 1.

When receiving such a message indicating that user authentication has failed, the control unit 102 of the image forming apparatus 1 causes the display unit 105 to display a message for notifying the user that user authentication has failed. On the other hand, when receiving a message indicating that the user has been successfully authenticated and the usage authorization data, the state changes to an authenticated state, and the control unit 102 controls the display unit 105 in accordance with the received usage authorization data.

For example, it is assumed that a circle mark is stored for function A, a cross mark is stored for function B, and a triangle mark is stored for function C in the table TB1, and that a circle mark is stored for function A, a cross mark is stored for function B, and a circle mark is stored for function C in the received usage authorization data. In this case, function A is available in an unauthenticated state and is also available on the basis of the usage authorization data. Thus, function A is available after authentication, and display related to function A may be performed. Function B is unavailable and display related to function B is not performed in an unauthenticated state. Since the usage authorization data for function B indicates a cross mark, function B is unavailable and display related to function B is not performed even after authentication. Function C is unavailable in an unauthenticated state, but is available on the basis of the usage authorization data. Thus, function C is available and display related to function C may be performed after authentication. That is, as illustrated in FIG. 14, images for selecting function A and function C are displayed on the display unit 105, and an image for selecting function B is not displayed on the display unit 105.

In this way, according to the exemplary embodiment, a screen for activating a function is displayed on the display unit 105 after user authentication in accordance with the usage authorization data that is set for individual users.

### Operation in Authenticated State

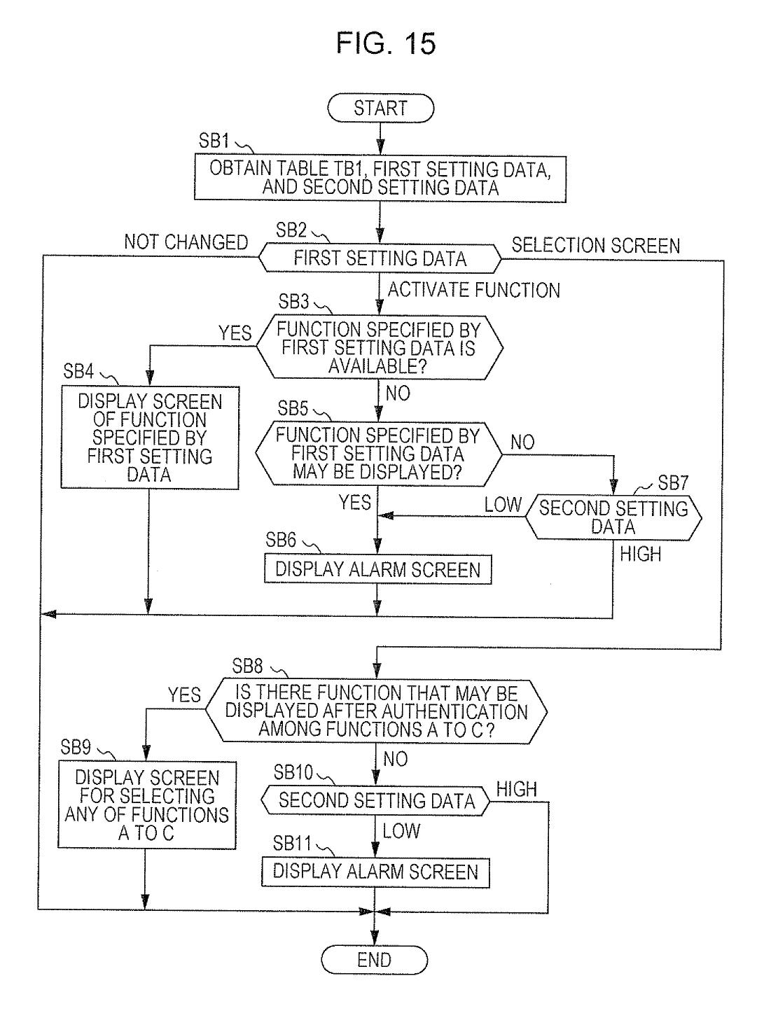

Next, an operation that is performed when a USB memory is connected to the second communication unit 110 in the image forming apparatus 1 in an authenticated state will be described. When a USB memory is connected to the second communication unit 110 in the image forming apparatus 1 in an authenticated state, the control unit 102 executes the process illustrated in FIG. 15.

First, the control unit 102 obtains the table TB1, the first setting data, and the second setting data, which are stored in the storage unit 103 (step SB1). If the content of the obtained first setting data is “not changed” (“not changed” in step SB2), the control unit 102 ends the process illustrated in FIG. 15 without changing the screen on the display unit 105. If the content of the obtained first setting data is any one of “activate function A”, “activate function B”, and “activate function C” (“activate function” in step SB2), the control unit 102 determines whether or not the function specified by the first setting data is available to the user.

If the function specified by the first setting data is available after user authentication, (“YES” in step SB3), the control unit 102 causes the display unit 105 to display a screen related to the function specified by the first setting data (step SB4). For example, if the content of the first setting data is “activate function A” and if function A is available after authentication, a screen related to function A is displayed.

If the function specified by the first setting data is unavailable even after user authentication and if display of the function specified by the first setting data may be performed (“NO” in step SB3 and “YES” in step SB5), the control unit 102 causes the display unit 105 to display an alarm screen for notifying the user that the function specified by the first setting data is unavailable (step SB6).

On the other hand, if the function specified by the first setting data is unavailable even after user authentication and if display of the function specified by the first setting data may not be performed (“NO” in step SB3 and “NO” in step SB5), the process proceeds to step SB7. If the content of the second setting data is “low”, (“low” in step SB7), the control unit 102 causes the display unit 105 to display an alarm screen (step SB6). If the content of the second setting data is “high” (“high” in step SB7), the control unit 102 ends the process illustrated in FIG. 15 without changing the screen displayed on the display unit 105.

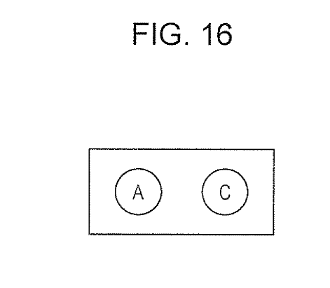

If the content of the first setting data is “selection screen” (“selection screen” in step SB2), the control unit 102 determines whether or not there is a function that may be displayed after authentication among functions A to C. If there is a function that may be displayed after authentication among functions A to C (“YES” in step SB8), the control unit 102 causes the display unit 105 to display the screen for selecting the function that may be displayed after authentication among functions A to C (step SB9). For example, in a case where the screen illustrated in FIG. 14 is displayed at the time of authentication, the screen illustrated in FIG. 16 is displayed when a USB memory is connected to the second communication unit 110.

If there is no function that may be displayed after authentication among functions A to C (“NO” in step SB8), the process proceeds to step SB10. If the content of the second setting data is “low”, (“low” in step SB10), the control unit 102 causes the display unit 105 to display an alarm screen for notifying the user that the function is unavailable (step SB11). If the content of the second setting screen is “high” (“high” in step SB10), the control unit 102 ends the process illustrated in FIG. 15 without changing the screen on the display unit 105.

As described above, the image forming apparatus 1 according to the exemplary embodiment stores the table TB1 and the first setting data. When an auxiliary storage device is connected to the image forming apparatus 1 in an authenticated state, a screen related to a function related to the auxiliary storage device is displayed on the basis of the table TB1 and the content of the first setting data, even if the user does not perform any operations.

Also, the image forming apparatus 1 according to the exemplary embodiment stores the second setting data. If a screen related to a function related to the auxiliary storage device is not displayed in an authenticated state, an alarm screen is displayed or the screen is not changed on the basis of the content of the second setting data.

### Modifications

The exemplary embodiment of the present invention has been described. The present invention is not limited to the above-described exemplary embodiment, and may be carried out in other various forms. For example, the above-described exemplary embodiment may be modified as described below. Furthermore, any combination of the above-described exemplary embodiment and the following modifications is acceptable.

In the above-described exemplary embodiment, the table TB2 is stored in the server apparatus 2, and the image forming apparatus 1 and the server apparatus 2 cooperate with each other to perform user authentication. Alternatively, the table TB2 may be stored in the image forming apparatus 1, and user authentication may be performed using the table TB2 stored in the image forming apparatus 1. Alternatively, whether or not a user is authorized to use a function may be determined using the usage authorization data stored in the table TB2 stored in the image forming apparatus 1.

In the above-described exemplary embodiment, a user inputs his/her user ID and password when performing user authentication. However, the manner of performing user authentication is not limited thereto. For example, the user ID may be stored in an IC card held by the user, the user ID stored in the IC card may be read by an IC card reader provided in the image forming apparatus 1, and whether or not the read user ID exists in the table TB2 may be determined to perform user authentication. Alternatively, user authentication may be performed using information indicating a physical feature of the user (for example, information indicating a fingerprint or iris).

Alternatively, steps SA6 and SA11 may be omitted in the process illustrated in FIG. 8. In this case, the authentication screen illustrated in FIG. 9 may be displayed or the screen displayed on the display unit 105 may not be changed if it is determined in step SA3 that a cross mark is stored and if a negative determination is made in step SA9.

Also, steps SB7 and SB10 may be omitted in the process illustrated in FIG. 15. In this case, an alarm screen may be displayed or the screen displayed on the display unit 105 may not be changed if a negative determination is made in step SB5 and if a negative determination is made in step SB8.

The programs stored in the ROM 102B may be provided in the state of being stored in a computer readable recording medium, such as a magnetic recording medium (magnetic tape, magnetic disk (hard disk drive (HDD) or flexible disk (FD))), an optical recording medium (optical disc or the like), a magneto-optical recording medium, or a semiconductor memory, and may be installed in the image forming apparatus 1. Alternatively, the programs may be downloaded to the image forming apparatus 1 via a communication line and may be installed therein.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an authentication unit that authenticates a user;
a communication unit that communicates with an external device connected thereto;
a function availability data obtaining unit that obtains, from a memory, function availability data that defines whether or not a function related to the external device is available;
a usage authorization data obtaining unit that obtains usage authorization data indicating whether or not the user is authorized to use the function; and
a display controller that causes, when the external device is connected to the communication unit, a display to display a screen related to authentication of the user in a case where the function availability data indicates that the function is unavailable in a state where the user has not been authenticated,
that causes, when the external device is connected to the communication unit, the display to display an image related to the function in a case where the usage authorization data indicates that the function is available and where the function availability data indicates that the function is available in a state where the user has been authenticated, and
that causes, when the external device is connected to the communication unit, the display to display an image for notifying the user that the function is unavailable in a case where the usage authorization data indicates that the function is unavailable in a state where the user has been authenticated.

2. The image forming apparatus according to claim 1, further comprising:
a protection level data obtaining unit that obtains protection level data indicating a protection level of the image forming apparatus, the protection level data representing at least any one of high and low,
wherein the display controller causes, when the external device is connected to the communication unit, the display not to display the screen related to authentication of the user in a case where the protection level data indicates that the protection level is high and where the function availability data indicates that the function is unavailable in a state where the user has not been authenticated, and
causes, when the external device is connected to the communication unit, the display not to display the image for notifying the user that the function is unavailable in a case where the protection level data indicates that the protection level is high and where the usage authorization data indicates that the function is unavailable in a state where the user has been authenticated.

3. An image forming method comprising:
authenticating a user;
communicating with an external device connected to a communication unit;
obtaining, from a memory, function availability data that defines whether or not a function related to the external device is available;
obtaining usage authorization data indicating whether or not the user is authorized to use the function;
causing, when the external device is connected to the communication unit, a display to display a screen related to authentication of the user in a case where the function availability data indicates that the function is unavailable in a state where the user has not been authenticated;
causing, when the external device is connected to the communication unit, the display to display an image related to the function in a case where the usage authorization data indicates that the function is available and where the function availability data indicates that the function is available in a state where the user has been authenticated; and
causing, when the external device is connected to the communication unit, the display to display an image for notifying the user that the function is unavailable in a case where the usage authorization data indicates that the function is unavailable in a state where the user has been authenticated.

4. The image forming method according to claim 3, further comprising:
obtaining protection level data indicating a protection level of an image forming apparatus, the protection level data representing at least any one of high and low;
causing, when the external device is connected to the communication unit, the display not to display the screen related to authentication of the user in a case where the protection level data indicates that the protection level is high and where the function availability data indicates that the function is unavailable in a state where the user has not been authenticated; and
causing, when the external device is connected to the communication unit, the display not to display the image for notifying the user that the function is unavailable in a case where the protection level data indicates that the protection level is high and where the usage authorization data indicates that the function is unavailable in a state where the user has been authenticated.

5. A computer readable medium storing a program causing a computer to execute a process, the process comprising:
authenticating a user;
obtaining, from a memory, function availability data that defines whether or not a function related to an external device is available;
obtaining usage authorization data indicating whether or not the user is authorized to use the function;
causing, when the external device is connected to a communication unit that communicates with the external device, a display to display a screen related to authentication of the user in a case where the function availability data indicates that the function is unavailable in a state where the user has not been authenticated;
causing, when the external device is connected to the communication unit, the display to display an image related to the function in a case where the usage authorization data indicates that the function is available and where the function availability data indicates that the function is available in a state where the user has been authenticated; and
causing, when the external device is connected to the communication unit, the display to display an image for notifying the user that the function is unavailable in a case where the usage authorization data indicates that the function is unavailable in a state where the user has been authenticated.

6. The computer readable medium according to claim 5, the process further comprising:
obtaining protection level data indicating a protection level of an image forming apparatus, the protection level data representing at least any one of high and low;
causing, when the external device is connected to the communication unit, the display not to display the screen related to authentication of the user in a case where the protection level data indicates that the protection level is high and where the function availability data indicates that the function is unavailable in a state where the user has not been authenticated; and
causing, when the external device is connected to the communication unit, the display not to display the image for notifying the user that the function is unavailable in a case where the protection level data indicates that the protection level is high and where the usage authorization data indicates that the function is unavailable in a state where the user has been authenticated.
